(19) United States
(12) Patent Application Publication
(10) Pub. No.: US 2013/0283670 A1
(43) Pub. Date: Oct. 31, 2013

(54) Floating Pitfall Trap

(71) Applicants: Katherine A. Parys, Cleveland, MS (US); Seth J. Johnson, Baton Rouge, LA (US)

(72) Inventors: Katherine A. Parys, Cleveland, MS (US); Seth J. Johnson, Baton Rouge, LA (US)

(73) Assignee: BOARD OF SUPERVISORS OF LOUISIANA STATE UNIVERSITY AND AGRICULTURAL AND MECHANICAL COLLEGE, Baton Rouge, LA (US)

(21) Appl. No.: 13/991,965

(22) PCT Filed: Dec. 7, 2011
(86) PCT No.: PCT/US2011/063666

§ 371 Date: Jul. 16, 2013

Related U.S. Application Data
(60) Provisional application No. 61/420,896, filed on Dec. 8, 2010.

(51) Int. Cl. A01M 1/10; A01M 23/02

(52) U.S. Cl. CPC A01M 1/10; A01M 23/02
USPC 43/107

(57) ABSTRACT

A floating aquatic pitfall trap system is disclosed for long-term monitoring of hydro- and hygrophilous insects, including for example biological control agents associated with aquatic vegetation.

The benefit of the Dec. 8, 2010 filing date of the U.S. provisional patent application Ser. No. 61/420,896 is claimed under 35 U.S.C. §119(e) in the United States, and is claimed under applicable treaties and conventions in all countries.

### TECHNICAL FIELD

This invention pertains to a floating pitfall trap for sampling insects and other arthropods.

### BACKGROUND ART

Low light intensity and long wet periods have historically regulated undergrowth in freshwater swamps. Aquatic invasive plants are recently becoming the dominant form of vegetation encountered. Some of the more common emergent and floating aquatic plants in southern Louisiana, where this invention was developed, include: Common Salvinia (Salvinia minima), Giant Salvinia (S. molesta), Water Hyacinth (Eichornia crassipes), Water Lettuce (Pista stratiotes), Aligatorweed (Alternanthera philoxeroides), and Pennywort (Hydrocotyle sp.). Under the right environmental conditions, these plants can combine to form floating mats that act as islands of vegetation, sometimes referred to as floatants.

High densities of aquatic vegetation in waterways not only physically obstruct waterways but can decrease light availability, reduce available dissolved oxygen, alter pH levels, and provide a breeding area for disease transmitting mosquitoes. Many of these invasive plants are also the subject of intensive biological control efforts using introduced insects.

There is an unfilled need for improved traps for collecting insects in wetlands and other aquatic habitats. Such traps may be used to monitor the progress of biological control with introduced insects, to monitor the density of invasive insect species, and/or to evaluate general insect and spider biodiversity of habitats that are hard to sample or access due to standing water or dense vegetation.

Different types of insect traps will often collect very different groups of insects. Highly mobile or nocturnal insects can easily be missed using common net- and corer-based sampling methods.

Collecting insects in wetlands with dense vegetation is difficult due to standing water and high structural complexity. Over 30 different methods that are commonly used to collect arthropods in and around aquatic and emergent macrophytes are provided in Merritt, R. W., K. W. Cummings, and M. B. Berg. 2008. An Introduction to the Aquatic Insects of North America. Kendall/Hunt Publishing (Fourth Edition) (Chapter 3, pages 15-38).

“Floating pitfall” traps allow the collection of specimens that might be missed by other types of aquatic sampling, partially due to the longer collecting periods that are possible with floating pitfall traps. Floating pitfall traps have been used to sample amphibians and spiders but rarely for insects. Pitfall trapping of insects is commonly used in terrestrial systems for biodiversity studies. Pitfall traps operate continuously, are inexpensive and easy to use, and result in large species-rich samples. Forests and agricultural areas are most commonly sampled with pitfall traps, but these traps are rarely used in areas that could potentially be flooded.

There have been a variety of floating trap designs published. The first description of a floating trap that was designed to sample Hydrellia sp. (Diptera: Ephydridae) in rice fields was provided for in Grigarick, A. A., 1959. A Floating Pan Trap for Insects Associated with the Water Surface. Journal of Economic Entomology. 52:348-349. The design consisted of a round 20.3-centimeter diameter by 3.2 centimeter deep aluminum pan inserted into a piece of wood. The trap was filled with water and a wetting agent, and was checked every one to three days. The trap was non-selective and caught a wide variety of insects as well as other animals. Due to the shallow design it was swamped easily by water movement. Other designs consisted of a 0.35-liter small pot (unspecified type) weighted with wax and lead, and inserted into a 20.0 centimeter×12.0 centimeter piece of cork (Ruzicka, V. 1982. Modifications to improve the efficiency of modern pitfall traps. Secretary's Newsletter. 34:2-4.); or a 3.5 centimeter×8.0 centimeter vial inserted into a 12.0 centimeter square board (Renner, F. 1986. Zur Nischendifferenzierung bei Pirata-Arten (Aranaeida, Lycosidae). Ver naturwiss Ver Hamburg 28:75-90). A floating pitfall trap with a double cup, in which a smaller cup for collecting fluid was nested inside a larger outer cup (10.0 centimeter diameter), which in turn was weighted with mud and rocks was constructed in Graham, A. K., C. M. Buddle, and J. R. Spence. 2003. Habitat Affinities of Spiders Living Near a Freshwater Pond. Journal of Arachnology 31:78-89. The double cup was then inserted into a 15.0 centimeter piece of square foamed polystyrene.

We constructed and field-tested a variety of published trap designs before designing our own. Traps based on Grigarick (1959) were quickly sunk by turtles at our field site. Traps following Renner (1986) would not stay level with the water's surface, and the openings were easily blocked by debris. The design from Ruzicka (1982) fared slightly better, but the cork used for the float degraded quickly in the water, and Louisiana's high summer temperatures melted the wax, fouling samples. The trap of Graham et al. (2003) accumulated water and other organic materials between the nested cups. Water accumulation between two cups rendered the trap useless, as the inner cup floated in the accumulated water and raised the lip above the level of the surrounding vegetation, this shift in cup level resulted in a zero catch. Additionally, the Graham et al. (2003) trap used trapping containers with sloping sides allowing for possibility of escape for some highly agile taxa. We also had problems with the foamed polystyrene float disintegrating and degrading in the heat and sun.

### DISCLOSURE OF THE INVENTION

We have discovered an inexpensive, robust trapping system to effectively sample insects associated with emergent and floating aquatic vegetation, and other aquatic habitats. The novel traps may be deployed in the field for long periods of time without maintenance.

While we were specifically interested in collecting insects associated with pleuston vegetation (that at the surface), the traps may easily be used in other types of aquatic habitats, or they may be used as part of a larger sampling regime to complement other sampling methods.

A team of four people has serviced 100 of the novel traps in the field in 3-4 hours, and later sorted the catches in the lab. Each trap collection required an average total processing time of 20 minutes per trap per service date. This was an efficient rate that allowed us to take and process a higher number of samples than if we had instead taken whole plant samples.

The novel trap design provides an easy and efficient way for making sequential collections of hygro- and hydrophilous insects associated with emergent vegetation or other aquatic habitats, for a wide variety of taxonomic or ecological studies. Previous studies on insects associated with Salvinia spp. have ranged from 10 spp. (Forno and Bourne 1984) to 113 spp. (Pelli and Barbosa 1998). In other similar habitats in Louisiana, surveys of insects associated with floating aquatic vegetation have found 66 spp. (Sklar 1983, 1985) to 85 spp. (Ziser 1978). Our collection of 245 species of adult insects associated with Salvinia spp. is much higher than has been previously reported in other studies with similar objectives. Use of these traps does not require the removal of vegetation or disturbance to the local community, and allows for repeated sampling in the same physical location.

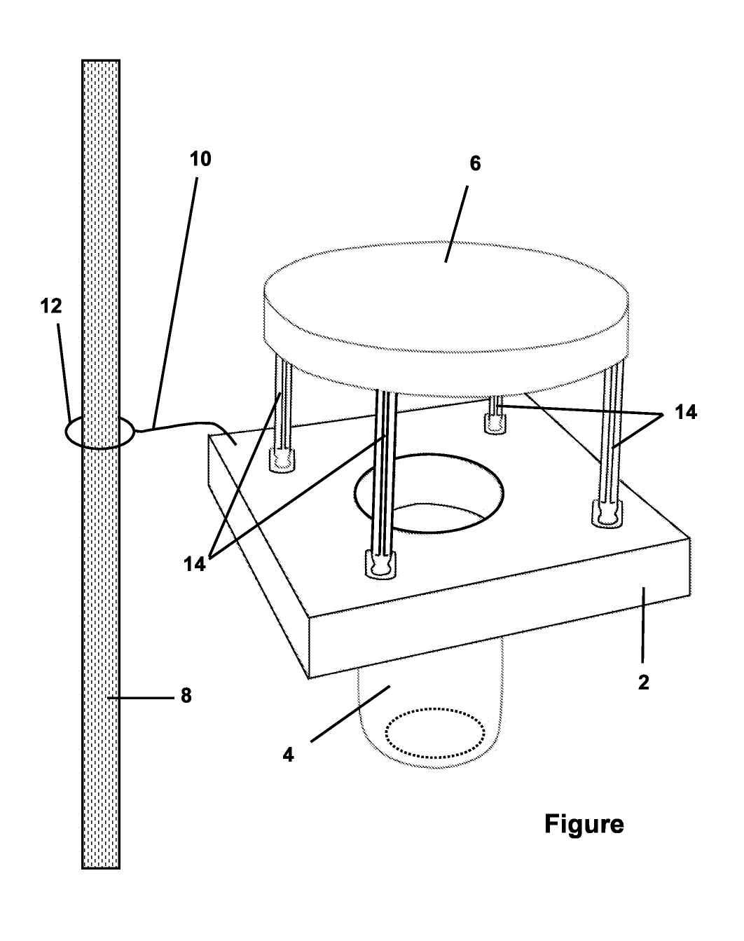

The novel floating trap design, one embodiment of which is depicted in FIG. 1, includes a base 2, a single trapping container 4, a cover 6, an anchoring stake 8, and a tether 10.

In a preferred embodiment, the tether 10 is attached to a ring 12 that is loosely placed over the anchoring stake 8 to prevent substantial horizontal movement away from the designated site, while allowing vertical movement with changes in water level.

The base 2 floats on the surface of the water, and weights (not shown in FIG. 1) are placed in the bottoms of the single trapping container 4. Preferably, the weights are such that the top of the foam rests just slightly above the surrounding vegetation.

The cover 6 reduces debris and precipitation in the trap, and is connected to the base by rods 14.

In a preferred embodiment, a preservative, for example ethylene glycol, is added to the trapping container 4 in a quantity sufficient to lower the edges of the base 2 so it is level with the top of the vegetation.

In the most preferred embodiment, a wetting agent, for example dish detergent, is also added to the trapping container 4 to minimize arthropod escape from the trap.

### BRIEF DESCRIPTION OF THE DRAWING

The FIGURE depicts one embodiment of the novel floating pitfall trap design.

### MODES OF USING THE INVENTION

Example: Embodiments of the Novel Trap Used Near Gramercy, La.

Traps were set and loaded during the spring on a privately owned tract of land just north of Gramercy, La. This site is a Cypress-Tupelo-Blackgum freshwater swamp, and the landscape is dominated by Baldcypress (Taxodium distichum). In recent years aquatic invasive vegetation has increasingly taken over the open water. Commonly encountered plants include: common salvinia (Salvinia minima), water hyacinth (Eichornia crassipes), and pennywort (Hydrocotyle sp.).

The floating pitfall traps were placed in a 10×10 grid, with trap locations marked by 2-meter plastic coated steel garden stakes topped with neon plastic flagging. The stakes were placed 5 meters apart for a total of 100 traps in a 50 square meter grid. Traps were set, loaded, and launched in May and were emptied every two weeks until November. Catches were labeled with the trap coordinate location and trap pick up date, and preserved in the lab in ethylene glycol until processing.

The traps were prepared as shown in the FIGURE. The floating base 2 comprised a 15.0 centimeter×15.0 centimeter piece of 2.5 centimeter thick black polyethylene packaging foam with a 6.7 centimeter diameter hole cut in the center. For the trapping container 4, a canning jar, for example Ball® (Daleville, Ind.) standard mouth 236.5-milliliter glass canning jar, was hot-glued to the foam base. A plastic trapping container could also be used. 85.0 grams of weights, for example fishing weights, were placed in the bottom of the trapping container. The weights were encased in FloraCraft® (Ludington, Mich.) liquid acrylic resin, which was poured over the weights to cover them in the bottom of the jar in order to prevent lead contamination in the environment. Other encasing materials, such as plaster or concrete with a sealant may be used to suspend the weights.

The ends of four K'nex® polymer rods (Hatfield, Pa.) “Standard Black Rod/Connectors” (Part #90914) were hot-glued into the foam base, 3.7 centimeters from the hole for the jar. These rods 14 connect the cover 6 to the base 2. The cover 6 was made from a Fisher® (Hampton, N.H.) clear polystyrene Petri dish (15.0 mm×150.0 mm) with four K'nex® “Standard Yellow Rods 3 7/16” (Part #90953) spaced evenly on the inside of the edge of the Petri dish and hot-glued in place. Covers have been reported not to affect the composition of trap catches in terrestrial systems, so we chose to use a clear cover to minimize possible bias and reduce debris in the trap. A landscaping stake, for example Gardener's Blue Ribbon® (Lititz, PA) 2 meter plastic-coated steel landscape stake, served as anchoring stake 8. The trap was attached to the stake 8 by a tether 10, which comprised a 2.5 centimeter key ring 12 attached to a 30.0 centimeter piece of 49-strand nylon-covered steel jewelry wire, which was attached to one corner of the foam. The ring 12 was placed over the stake 8, preventing any substantial horizontal drift but allowing vertical movement with changes in water level.

Jars were filled half full with approximately 75 milliliters of ethylene glycol, for example Prestone® Extended Life Antifreeze/Coolant, as a preservative for each trap date. Other preservatives that could be used include propylene glycol, soapy water, or alcohol. This quantity of fluid lowered the edges of the polyethylene foam level with the top of the pleuston vegetation. While propylene glycol has gained popularity in terrestrial pitfall trapping methods due to low mammalian toxicity, it has a much higher biological oxygen demand in freshwater systems than ethylene glycol and could increase oxygen depletion if spilled. A few drops of dish detergent, for example Palmolive® Safe+Clear, were added to each trap as a wetting agent, to increase wetting and minimize arthropod escape from traps.

After being loaded in the field, the traps were checked every two weeks. During the time that the traps were in the field, some failed from problems such as: animals eating the foam, falling branches, and turtles using a trap as a platform. Traps that became submerged stayed buoyant at the water's surface and still collected insects, even after the jar flooded. Fewer than 50 individual trap catches out of 1300 were lost during the first field season due to being overturned or becoming fully submerged. After one field season (six months) of environmental exposure, the foam on some traps began to lose buoyancy and was replaced before a second field season. All other pieces and parts were re-used for the second field season.

A total of 7,719 adult insect specimens representing 245 species within 70 families and 7 orders were collected over two years of sampling. The Coleoptera were both the most species-rich (176 species) and the most abundant (4,337 individuals). Other orders collected included Hymenoptera, Hemiptera, Orthoptera, Odonata, Psocoptera, and Blattodea. Of particular interest were four previously undescribed species. One of these species is known only from this location, and solely from this new trapping method.

It took our field team of four an average of 3-4 hours to service 100 traps in the field, and an additional average processing time of approximately 15 minutes per trap in the lab. The total processing time was thus around 20-25 minutes per trap. By comparison, heavily vegetated dip net and corer samples that can take 2-5 hours, each, to process.

The trap design provided an easy and efficient way for making sequential collections of hygro- and hydrophilous insects associated with emerging vegetation for a variety of taxonomic and ecological studies. Our collection of 245 species of adult insects was richer than has previously been reported for other studies on arthropods associated with Salvinia spp. Use of the traps does not require removal of vegetation samples or disturbance to the local community, and allows for repeat sampling in the same physical location.

The complete disclosures of all references cited in this specification are hereby incorporated by reference. Also incorporated by reference is the complete disclosure of priority application Ser. No. 61/420,896. In the event of an otherwise irreconcilable conflict, however, the present specification shall control.

We claim:

1. Apparatus for collecting hygrophilous arthropods, hydrophilous arthropods, or both in an aquatic or semi-aquatic environment; wherein said apparatus comprises a float, a single container, a tether, and an anchor; and wherein:
(a) the top of said single container is open; said container is removably or permanently affixed to said float; said container passes through a hole in the center of said float; and the open top of said container is either level with or below the top of said float, thereby providing a path for an insect walking on the top of the float to fall into said container;
(b) said anchor is adapted to be removably or permanently affixed into the earth or to an immobile object; and said anchor comprises a vertical rod;
(c) said tether comprises a first end and a second end; the first end of said tether is removably or permanently affixed to said float, or is adapted to be removably or permanently affixed to said float; the second end of said tether comprises a sliding connector; and said sliding connector is slidably attached to said vertical rod, or is adapted to be slidably attached to said vertical rod, thereby allowing said sliding connector to slide freely over said vertical rod in the vertical direction, while restricting the movement of said sliding connector in a horizontal direction;
(d) the buoyancy of said apparatus is either fixed or adjustable so that, when the apparatus is placed into water, the top of said float rests at a selected distance above the surface of the water;
whereby:
(e) said apparatus is adapted to be used in collecting hygrophilous arthropods, hydrophilous arthropods, or both in an aquatic or semi-aquatic environment in the following process: (i) affixing said anchor into the earth or to an immobile object; (ii) placing said float into the water, whereby the top of said float rests at a selected distance above the surface of the water; (iii) slidably attaching said sliding connector to said vertical rod, whereby said float is free to move vertically if the water level rises or falls, while the movement of said float horizontally away from said anchor is restricted by said tether; (iv) leaving said apparatus in position in the water for a period of time; and (v) collecting arthropods during the period of time by allowing the arthropods to walk across the top of said float, and allowing some of these arthropods to fall into said container.

2. The apparatus of claim 1, additionally comprising one or more weights to adjust the buoyancy of said apparatus.

3. The apparatus of claim 1, wherein said container contains a preservative adapted to kill and preserve arthropods that fall into said container.

4. The apparatus of claim 3, wherein said preservative comprises ethylene glycol.

5. The apparatus of claim 1, wherein said container contains a wetting agent to inhibit arthropod escape from said container.

6. The apparatus of claim 5, wherein said wetting agent comprises an aqueous surfactant solution.

7. The apparatus of claim 1, additionally comprising a cover positioned over and spaced above said container, so that said cover does not impede access by arthropods to said container, and so that said cover reduces the amount of debris or precipitation entering said container.

8. The apparatus of claim 7, wherein said cover is transparent.

9. The apparatus of claim 1, wherein said sliding connector comprises a ring that fits loosely around said anchor.
